(19) United States
(12) Patent Application Publication
(10) Pub. No.: US 2017/0308760 A1
(43) Pub. Date: Oct. 26, 2017

(54) COLLISION AVOIDANCE METHOD AND APPARATUS USING DEPTH SENSOR

(71) Applicant: SAMSUNG SDS CO., LTD., Seoul (KR)

(72) Inventors: Ki Sang KWON, Seoul (KR); Min Kyu KIM, Seoul (KR); Du Won PARK, Seoul (KR); Sung Ho JANG, Seoul (KR)

(73) Assignee: SAMSUNG SDS CO., LTD., Seoul (KR)

(21) Appl. No.: 15/491,065

(22) Filed: Apr. 19, 2017

(30) Foreign Application Priority Data
Apr. 26, 2016 (KR) 10-2016-0050829

(51) Int. Cl. G06K 9/00; G06T 7/11; G08G 1/16; G06T 7/70

(52) U.S. Cl. CPC G06K 9/00805; G06T 7/70; G06K 9/00798; G08G 1/16; G06T 7/11; G06T 2207/30256; G06T 2207/30261; G06T 2207/10028

(57) ABSTRACT

Provided are a collision avoidance method using a depth sensor, the method comprises receiving depth-based image information and identifying a path in the received depth-based image information, determining a depth level for each region of the depth-based image information, setting one or more distance-based sensing regions on the identified path based on the determined depth level, determining whether an object is detected in each of the set distance-based sensing regions and outputting a control signal for controlling the operation of a transport when determining that the object has been detected.

This application claims the benefit of Korean Patent Application No. 10-2016-0050829, filed on Apr. 26, 2016, in the Korean Intellectual Property Office, the disclosure of which is incorporated herein by reference in its entirety.

### BACKGROUND

### 1. Field

The present inventive concept relates to a collision avoidance method and apparatus using a depth sensor, and more particularly, to a method and apparatus for avoiding a collision with an obstacle ahead using a depth sensor.

### 2. Description of the Related Art

To prevent a transport apparatus from colliding with an object such as a preceding vehicle, a person or a thing, a front sensor is attached to the front of the transport apparatus. As the front sensor, a laser sensor is widely used. In order for the laser sensor to sense a preceding vehicle on the movement path of a vehicle, a reflector should be attached to the rear of the preceding vehicle. On the other hand, in order to prevent the laser sensor from wrongly detecting a vehicle on another path which has no possibility of colliding with the vehicle, a non-reflector should be attached between the movement path of the vehicle and the another path.

Accordingly, in the work environment in which the transport apparatus is used, an object to be sensed and an object to be not sensed should be distinguished from each other, and a reflector or a non-reflector should be attached to the transport apparatus or the work environment.

In addition, to prevent the transport apparatus from colliding with a person or an object other than a preceding vehicle, another sensor should be provided in the transport apparatus, in addition to the laser sensor. In this case, additional cost is incurred for the additional sensor, and each sensor should be managed separately according to its life cycle.

Nevertheless, there is no collision avoidance apparatus which can avoid collision by detecting all objects such as a preceding vehicle, a person and a thing with a single sensor and does not require the attachment of a reflector.

### SUMMARY

Aspects of the inventive concept provide a method and apparatus for avoiding a collision with an object by analyzing an image of a region ahead using a depth sensor.

Specifically, aspects of the inventive concept provide a method and apparatus for setting a sensing region for each depth level according to the distance from a transport apparatus.

Aspects of the inventive concept also provide a method and apparatus for changing a sensing region for sensing an object to be avoided for fear of collision by analyzing a path along which a transport apparatus travels.

Aspects of the inventive concept also provide a method and apparatus for changing a sensing distance to an object to be avoided for fear of collision according to the travelling speed of a transport apparatus.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a collision avoidance method using a depth sensor, the method comprises receiving depth-based image information and identifying a path in the received depth-based image information, determining a depth level for each region of the depth-based image information, setting one or more distance-based sensing regions on the identified path based on the determined depth level, determining whether an object is detected in each of the set distance-based sensing regions and outputting a control signal for controlling the operation of a transport when determining that the object has been detected.

According to another aspect of the inventive concept, there is provided a collision avoidance apparatus, the collision avoidance apparatus comprises an image collection unit which receives depth-based image information, a control unit which identifies a path using the depth-based image information, determines a depth level for each region of the depth-based image information, sets one or more distance-based sensing regions on the identified path based on the determined depth level, determines whether an object is detected in each of the set distance-based sensing regions, generates a control signal for controlling the operation of a transport apparatus when determining that the object has been detected, and controls the control signal to be output to the transport apparatus, and a control signal output unit which outputs the control signal to the transport apparatus.

According to another aspect of the inventive concept, there is provide a computer program coupled to a computing device, the computer program is stored in a recording medium to execute an operation of receiving depth-based image information and identifying a path in the received depth-based image information; an operation of determining a depth level for each region of the depth-based image information, an operation of setting one or more distance-based sensing regions on the identified path based on the determined depth level, an operation of determining whether an object is detected in each of the set distance-based sensing regions and an operation of outputting a control signal for controlling the operation of a transport when determining that the object has been detected.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a transport apparatus, a collision avoidance apparatus, and depth-based image information according to an embodiment;

FIG. 2 is a block diagram of a collision avoidance apparatus according to an embodiment;

FIG. 3 is a flowchart illustrating a collision avoidance method using a depth sensor according to an embodiment;

FIG. 4 illustrates a change in depth level according to the distance from an object to be avoided for fear of collision, which is referred to in some embodiments;

FIG. 5 illustrates the relationship among the distance to an object to be avoided for fear of collision, a depth level, and a sensing region, which is referred to in some embodiments;

FIG. 6 illustrates a method of identifying whether a path in a sensing region ahead is a curved path or a straight path, which is referred to in some embodiments;

FIG. 7 illustrates a plurality of sensing regions set to sense an object to be avoided for fear of collision, which are referred to in some embodiments;

FIG. 8 illustrates a case where a sensing region is changed according to the traveling direction of a transport apparatus, which is referred to in some embodiments;

FIG. 9 illustrates a case where a sensing region is changed according to the traveling speed of a transport apparatus, which is referred to in some embodiments; and

FIG. 10 illustrates a case where a sensing region is changed according to the traveling direction and speed of a transport apparatus, which is referred to in some embodiments.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

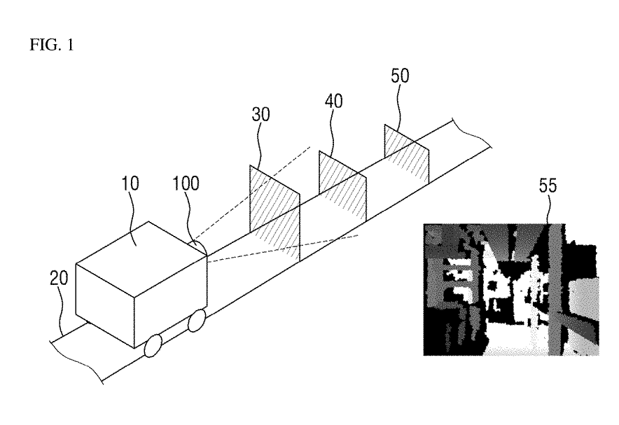

FIG. 1 illustrates a transport apparatus 10, a collision avoidance apparatus 100, and depth-based image information according to an embodiment.

Referring to FIG. 1, the transport apparatus 10 may move along a predetermined path such as a track 20 and transport materials. The transport apparatus 10 may be, for example, an overhead hoist transport (OHT) or an automated guided vehicle (AGV). The track 20 may be, for example, a rail. In FIG. 1, the track 20 is disposed on a bottom surface of the transport apparatus 10. However, this is merely an example, and the track 20 can also be disposed on a ceiling surface of a building so that the transport apparatus 10 can travel. In addition, the transport apparatus 10 may be a transportation means such as a train.

The transport apparatus 10 may include a communication module for performing wired or wireless communication with the collision avoidance apparatus 100.

The collision avoidance apparatus 100 is a computing device that receives an image (hereinafter, referred to as a forward image) of an area ahead of the transport apparatus 10, analyzes the received image, and controls the operation of the transport apparatus 10 based on the analysis result. According to an embodiment, the collision avoidance apparatus 100 may include a communication module for performing wired or wireless communication with the transport apparatus 10. Alternatively, according to an embodiment, the collision avoidance apparatus 100 may be integrated into the transport apparatus 10 as a component of the transport apparatus 10.

The collision avoidance apparatus 100 may be attached to the front of the transport apparatus 10. Alternatively, some components of the collision avoidance apparatus 100 may be included in the transport apparatus 10, and the other components required for forward image collection may be located on an outer surface of the transport apparatus 10.

The collision avoidance apparatus 100 may set sensing regions 30, 40 and 50 at predetermined distances from the transport apparatus 10 to detect an object located ahead of the transport apparatus 10 and may determine whether an object, which is likely to collide with the transport apparatus 10, is detected in each of the sensing regions 30, 40 and 50. In FIG. 1, three sensing regions 30, 40, and 50 are set at a short distance, a middle distance, and a long distance, respectively. The number of the sensing regions 30, 40 and 50 and the distance between the sensing regions 30, 40 and 50 may be determined according to the setting by a user or a manufacturer of the collision avoidance apparatus 100. Alternatively, the number and distance of the sensing regions 30, 40 and 50 may be determined by the collision avoidance apparatus 100 according to the traveling direction and speed of the transport apparatus 10.

An image 55 is a forward image of the transport apparatus 10 photographed by the collision avoidance apparatus 100. In FIG. 1, the image 55 is shown as an example of a forward image input through an infrared ray (IR)-based depth sensor. According to the image 55, an object located ahead of the transport apparatus 10 can be distinguished by a depth value according to distance, instead of the texture or color information of the object. The collision avoidance apparatus 100 according to the embodiment can include one or more sensors to collect forward images of the transport apparatus 10. However, a case where an object is detected using an IR-based depth sensor will be mainly described below.

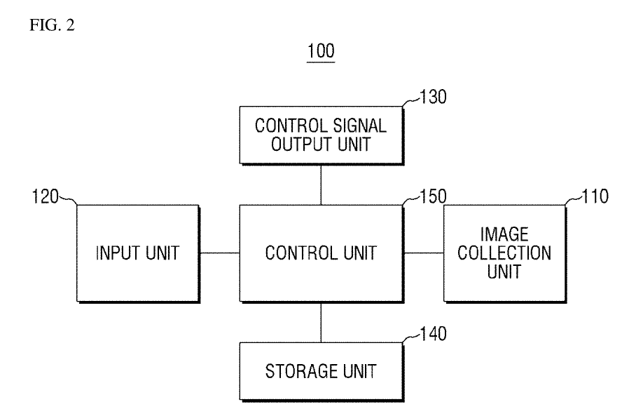

The configuration and operation of the collision avoidance apparatus 100 will now be described in detail with reference to FIG. 2. FIG. 2 is a block diagram of a collision avoidance apparatus 100 according to an embodiment.

Referring to FIG. 2, the collision avoidance apparatus 100 may include an image collection unit 110, an input unit 120, a control signal output unit 130, a storage unit 140, and a control unit 150.

The image collection unit 110 may process an image frame such as a still image or a moving image. In particular, the image collection unit 110 is disposed at the front of the transport apparatus 10 to receive a forward image of the transport apparatus 10.

The image collection unit 110 may include one or more sensors for collecting images of the area ahead of the transport apparatus 10. For example, the image collection unit 110 may include an IR-based depth sensor. The image collection unit 110 may convert a collected image into a data signal and provide the data signal to the control unit 150.

The input unit 120 receives various settings from a user of the collision avoidance apparatus 100. To this end, the input unit 120 may include a button, a touch pad, or a touch screen. When configured as a touch screen, the input unit 120 may display driving information and/or various state information of the transport apparatus 10.

The control signal output unit 130 outputs a control signal for controlling the operation of the transport apparatus 10 to the transport apparatus 10. That is, the control signal output unit 130 may provide the transport apparatus 10 with a control signal for instructing acceleration, deceleration, and stop of the transport apparatus 10. To this end, the control signal output unit 130 may include a communication module for performing wired or wireless communication with the transport apparatus 10. In particular, according to embodiments, the communication module may include a short-range communication module. For example, the short-range communication module may include a communication module that supports at least one of Bluetooth™, radio frequency identification (RFID), infrared data association (IrDA), ultra wideband (UWB), ZigBee, near field communication (NFC), wireless-fidelity (Wi-Fi), and Wi-Fi direct technology. The communication module may also be included in the collision avoidance apparatus 100 separately from the control signal output unit 130.

The storage unit 140 stores various data, commands, and/or information. The storage unit 140 may store one or more programs for providing a collision avoidance method of the collision avoidance apparatus 100 according to embodiments. In particular, the storage unit 140 may store a forward image input through the image collection unit 110 or information about a depth level calculated by the control unit 150 for each distance and a sensing region matched to the depth level.

The storage unit 140 may temporarily or non-temporarily store data received from an external device, data input by a user, or the operation result of the control unit 150. The storage unit 140 may include a nonvolatile memory such as a read only memory (ROM), an erasable programmable ROM (EPROM), an electrically erasable programmable ROM (EEPROM) or a flash memory, a hard disk, a removable disk, or any type of computer-readable recording medium well known in the art to which the inventive concept pertains.

The control unit 150 controls the overall operation of each component of the collision avoidance apparatus 100. The control unit 150 may include a central processing unit (CPU), a micro-processor unit (MPU), a micro-controller unit (MCU), or any type of processor well known in the art to which the inventive concept pertains. In addition, the control unit 150 may perform an operation on at least one application or program for executing a method according to embodiments. In particular, the control unit 150 may generate a control signal for controlling the operation of the transport apparatus 10. The specific operation of the collision avoidance apparatus 100 under the control of the control unit 150 will be described later with reference to FIGS. 3 through 10.

Embodiments of the inventive concept will hereinafter be described in detail based on the above description of FIGS. 1 and 2.

FIG. 3 is a flowchart illustrating a collision avoidance method using a depth sensor according to an embodiment.

Referring to FIG. 3, the collision avoidance apparatus 100 may receive depth-based image information and identify a path in the received depth-based image information (operation S10). Here, the path may be a path along which the transport apparatus 10 is to travel. That is, the path may be a directional path such as a track on which the transport apparatus 10 travels or a rail with which the transport apparatus 10 is in contact.

Next, the collision avoidance apparatus 100 may determine a depth level for each region of the received depth-based image information. To this end, based on the received depth-based image information, the collision avoidance apparatus 100 may quantify the depth of each region of an image input through the image collection unit 110 according to distance.

The collision avoidance apparatus 100 may set a distance-based sensing region on the identified path (operation S20). Here, the distance-based sensing region may be a region of the received depth-based image information such as the image 55 of FIG. 1. The distance-based sensing region is a region in which the collision avoidance device 100 tries to detect an object in order to avoid a collision with an object located ahead of the transport apparatus 10. That is, the collision avoidance apparatus 100 may determine whether an object is detected in the distance-based sensing region. If the object is detected, the collision avoidance apparatus 100 may determine whether the object is likely to collide with the transport apparatus 10.

Then, the collision avoidance apparatus 100 may output a control signal for controlling the transport apparatus 10 in response to the result of determining whether the object is detected or the result of determining whether the object is likely to collide with the transport apparatus 10.

The image collection unit 110 collects a forward image at a wide angle of view in consideration of a case where the path has a curved section. Therefore, the whole image such as the image 55 is input to the collision avoidance apparatus 100. Once the distance-based sensing region is set, the collision avoidance apparatus 100 does not detect objects outside the sensing region, thereby reducing the amount of computation.

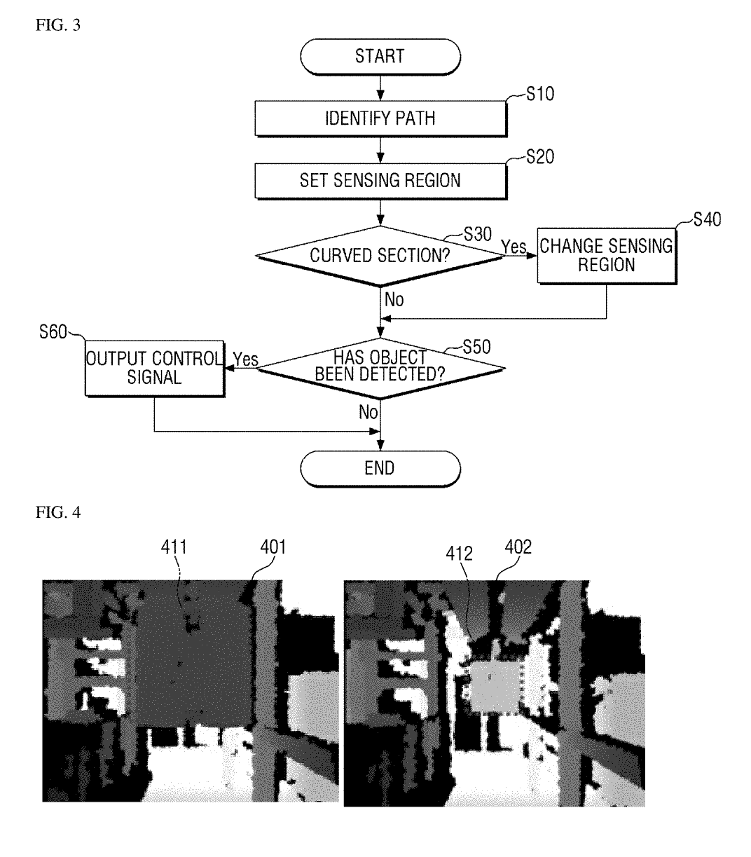

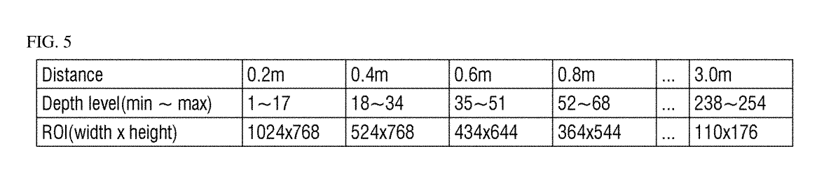

A specific method by which the collision avoidance apparatus 100 sets a sensing region will be described later with reference to FIGS. 4 through 10.

Based on the received depth-based image information, the collision avoidance apparatus 100 may determine whether a curved section is identified on the path along which the transport apparatus 10 is to travel (operation S30). The collision avoidance apparatus 100 may also determine whether a straight section is identified on the path along which the transportation apparatus 10 is to travel. The collision avoidance apparatus 100 may identify the curved section on the path by referring to the received depth-based image information while the transport apparatus 10 is being driven. Alternatively, the collision avoidance apparatus 100 may identify the curved section on the path based on the received depth-based image information when the transport apparatus 10 is at a standstill.

When the curved section is identified on the path along which the transport apparatus 10 is to travel, the collision avoidance apparatus 100 may change the sensing region set in operation S20 based on the identified curved section (operation S40).

When the curved section is not identified, that is, when the path along which the transport apparatus 10 is to travel is a straight section, the collision avoidance apparatus 100 may determine whether an object is detected in the sensing region set in operation S20 (operation S50). Alternatively, even when the curved section is identified, the collision avoidance apparatus 100 may determine whether an object is detected in the sensing region changed in operation S40 (operation S50).

When determining that the object has been detected, the collision avoidance apparatus 100 may generate a control signal for controlling the operation of the transport apparatus 10. The control signal may include an instruction for controlling operations such as acceleration, deceleration, stop, start, etc. of the transport apparatus 10. The generated control signal may be output to the transport apparatus 10 (operation S60). That is, the generated control signal is transmitted to the transport apparatus 10 to control the operation of the transport apparatus 10.

Each operation of FIG. 3 will hereinafter be described in detail with reference to FIGS. 4 through 10.

FIG. 4 illustrates a change in depth level according to the distance from an object to be avoided for fear of collision, which is referred to in some embodiments.

In FIG. 4, an image 401 and an image 402 are illustrated as example images input through the image collection unit 110. Each region of the images 401 and 402 is represented by a different brightness level. That is, each region and object of a forward image has a different depth according to the distance from the transport apparatus 10, and such a difference in depth is represented by a difference in brightness. Here, different brightness levels can be substituted with different data values, and the data values can be referred to as depth levels.

Assuming that a depth level range is expressed as an 8-bit range of 0 to 255, a structure or an object located close to the transport apparatus 10 may be substituted with a value of close to 0, and a structure or an object located far away from the transport apparatus 10 may be substituted with a value of close to 255. Here, an undetectable distance too close or far from the transport apparatus 10 may be expressed as a value of 0 or 255. Based on these depth levels, the collision avoidance apparatus 100 may set a distance at which an object can be detected.

Regions lying even in the same plane can have different depth levels depending on the image collecting environment or object characteristics. Also, pixels included in one region of an image can have different depth levels. Thus, depth levels may have a certain range to identify objects, structures, and spaces that lie in the same plane. The depth level range and the detectable distance may vary according to the type or performance of the IR-based depth sensor included in the image collection unit 110.

Referring to the image 401 and the image 402, an image of each region is the same in the image 401 and the image 402, but there is a difference in depth between an object 411 and an object 412. That is, the object 411 is displayed darker than the object 412. This indicates that the object 411 is located closer to the transport apparatus 10 than the object 412. Thus, in this case, the depth level of the object 411 has a relatively lower value than the depth level of the object 412. The depth levels of a structure, a region, etc. in a plane where the object 411 is located have values similar to that of the depth level of the object 411 and have a predetermined range. The depth levels of a structure, a region, etc. in a plane where the object 412 is located also have values similar to that of the depth level of the object 412 and have a predetermined range.

The collision avoidance apparatus 100 may receive from the input unit 120 distance information between the transport apparatus 10 and an object when each depth level or each depth level range is obtained. Accordingly, a depth level or a depth level range may be matched to each piece of received distance information and stored in the storage unit 140.

The collision avoidance apparatus 100 may set one or more distance-based sensing regions on the identified path based on the determined depth levels. That is, the collision avoidance apparatus 100 may set a plurality of sensing regions for object detection.

FIG. 5 illustrates the relationship among the distance to an object to be avoided for fear of collision, a depth level, and a sensing region, which is referred to in some embodiments.

When a distance-based sensing region described above is set, the collision avoidance apparatus 100 may match information about the set sensing region to information about a depth level or a depth level range for each piece of distance information and store the matched information.

In FIG. 5, a table in which distance information, a depth level, and a sensing region (ROI) are matched and stored is illustrated as an example. Referring to FIG. 5, the smaller the distance, the lower the depth level range and the wider the region that should be identified by the collision avoidance apparatus 100. That is, when an object is located close to the transport apparatus 10, an image obtained has low brightness. Therefore, the depth level also has a low value, and the sensing region is relatively wide.

The table may be stored in the collision avoidance apparatus 100 in advance.

The collision avoidance apparatus 100 may identify a sensing region for each pre-stored depth level.

In addition, the collision avoidance apparatus 100 may set one or more distance-based sensing regions among the identified sensing region for each pre-stored depth level. The collision avoidance apparatus 100 may determine whether an object is detected in each of the distance-based sensing regions. For example, when three distance-based sensing regions are set like the sensing regions 30, 40 and 50 of FIG. 1, the collision avoidance apparatus 100 may determine whether an object is detected in each of the three distance-based sensing regions. Here, each distance-based sensing region set by the collision avoidance apparatus 100 may be matched to a depth level as shown in the table of FIG. 5.

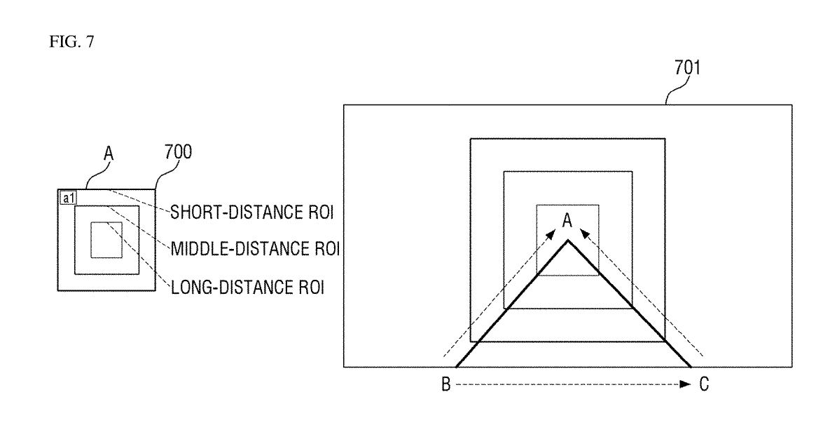

Here, the collision avoidance apparatus 100 may sense an area representing a matched depth level in a distance-based sensing region. For example, it is assumed that a depth level matched to a distance-based sensing region A has a range of 18 to 34 as shown in the table of FIG. 5. In particular, it is assumed that the distance-based sensing region A is the sensing region 30 of FIG. 1. Here, the sensing region 30 may be a short distance-based sensing region of FIG. 7 which will be described later.

In the sensing region 30, the collision avoidance apparatus 100 may sense an area having a depth level within the depth level range of 18-34 matched to the sensing region 30.

Here, it is assumed that the area is an area a1 included in the distance-based sensing region A of FIG. 7 which will be described later.

If the area a1 having a depth level within the depth level range of 18 to 34 is sense, the collision avoidance apparatus 100 may determine that an object has been detected.

When determining that the object has been detected, the collision avoidance apparatus 100 may output a control signal for controlling the operation of the transport apparatus 10.

In the above example, the collision avoidance apparatus 100 may sense the area a1 and also the movement of the area a1. That is, the collision avoidance apparatus 100 may sense that an object having the same depth level of 25 as the area a1 is moving from right to left in the distance-based sensing region A.

In the images 401 and 402 of FIG. 4, an object is moving away in a straight direction as indicated by reference numerals 411 and 412. Therefore, the brightness of the object is changed from dark to bright, and the depth level of the object is changed from a low value to a high value.

On the other hand, when an object moves in a lateral direction, the depth level of the object may remain unchanged because the object moves in the same plane. Therefore, when sensing that a depth level in a pixel of a second region of a received image is continuously changed to a depth level in a pixel of a first region of the received image, the collision avoidance apparatus 100 may determine that an object is moving.

The collision avoidance apparatus 100 may also determine the moving state of the object. For example, the collision avoidance apparatus 100 may determine the moving speed and direction of the object. In addition, the collision avoidance apparatus 100 may output a control signal for controlling the operation of the transport apparatus 10 based on the determined moving state of the object.

For example, the collision avoidance apparatus 100 may sense the moving speed of the object and determine whether to deviate from the area ahead before the transport apparatus 10 reaches the distance of the object. To this end, the collision avoidance apparatus 100 may use distance information matched to each depth level and stored accordingly. Alternatively, the collision avoidance apparatus 100 may determine that the object is moving at low speed or is at a standstill. In this case, the control signal may include a control command for decelerating or stopping the transport apparatus 10.

If a corresponding depth level is detected more than a certain portion in the sensing region set for each depth level as the following condition, the collision avoidance apparatus 100 may determine that an object is located within a range in which it can collide with the transport apparatus 10:

$$if {R}_{d} * {t}_{d} < {S}_{d} \{ \begin{matrix}then objects is present in region \\ else object is not present\end{matrix} , \qquad ( 1 )$$

where the subscript d is the number of distance steps in the table of FIG. 5, R_{d} is the area obtained by multiplying the width and height of a d^{th} sensing region, t_{d} is a critical coefficient used to determine the area occupation of the d^{th} sensing region, and S_{d} is the sum of pixels matched to a depth level of the d^{th} sensing region and satisfies the following condition:

S_{d}=ΣP(i,j), where depth level of P(i,j)⊂I′_{image(i,j)}, (2)

(all I′_{image(i,j)}|I″_{d-min}<I′_{image(i,j)} and I′_{image(i,j)}<I″_{d-max})

where i is the width of one of 0^{th} through d^{th} sensing regions, j is the height of one of the 0^{th} through d^{th} sensing regions, and P(i,j) is a pixel located in (i.j)^{th} position of sensing regions, and I″d-min is a min depth level of corresponding distance steps in the table of FIG. 5, and I″d-max is a max depth level of corresponding distance steps in the table of FIG. 5, and I′_{image} is a depth level that satisfies the condition of Equation (2), that is, a depth level at a (i, j)^{th} position which is within a depth level range of a sensing region.

The collision avoidance apparatus 100 may determine whether an object is detected in each of the 0^{th} through d^{th} sensing regions.

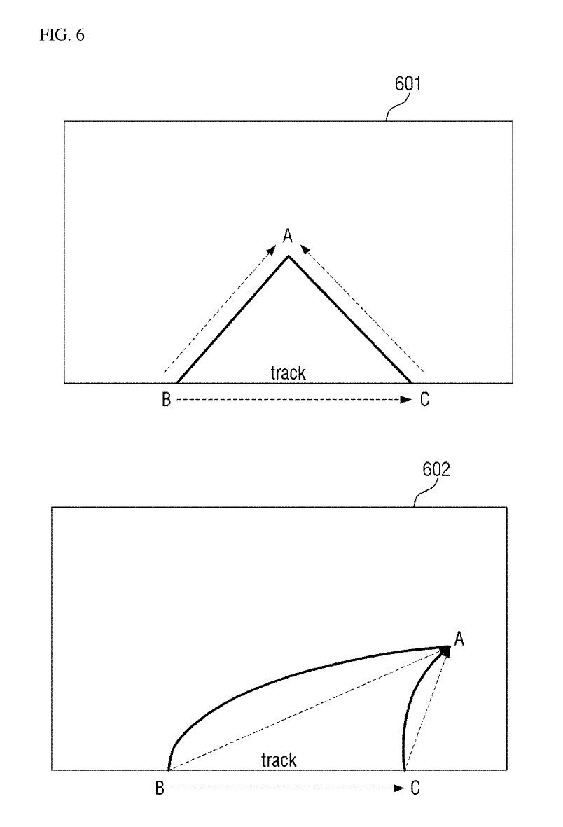

FIG. 6 illustrates a method of identifying the path of the transport apparatus 10, which is referred to in some embodiments. In particular, a method of identifying whether a path in a sensing region ahead of the transport apparatus 10 is a curved path or a straight path will be described with reference to FIG. 6. When the path is a curved path, a method of determining the curvature of the curved path will also be described.

Referring to FIG. 6, in operation S10, the collision avoidance apparatus 100 may identify a track, which guides the transport apparatus 10, in received depth-based image information.

Referring to an image 601, a first start point B, a second start point C and a vanishing point A of a track are shown. The collision avoidance apparatus 100 may generate a first direction vector connecting B and A and a second direction vector connecting C and A. If a length value of the first direction vector BA and a length value of the second direction vector CA are equal, the collision avoidance apparatus 100 may identify the path of the identified track as a straight section.

Referring to an image 602, a first direction vector BA and a second direction vector CA are generated as in the description of the image 601. In this case, if a length value of the first direction vector BA and a length value of the second direction vector CA are different, the collision avoidance apparatus 100 may identify the path of the identified track as a curved section in operation S30.

Here, the collision avoidance apparatus 100 may also determine the curvature of the curved section based on the length value of the first direction vector BA and the length value of the second direction vector CA. For example, when the length value of the first direction vector BA is larger than the length value of the second direction vector CA by a greater difference, the curvature of the curved section of the path is larger.

According to an embodiment, the collision avoidance apparatus 100 may also generate a horizontal vector BC connecting the first start point B and the second start point C in the image 602. In this case, the collision avoidance apparatus 100 may measure an angle (hereinafter, referred to as a first internal angle) between the vector BC and the vector CA and an angle (hereinafter, referred to as a second internal angle) between the vector BC and the vector BA and identify the path of the identified track as a curved section based on the measured angles.

That is, the collision avoidance apparatus 100 may compare the first internal angle and the second internal angle and identify the path of the identified track as a straight section when the two angles are equal and identify the path of the identified track as a curved section when the two angles are different. In addition, when the first internal angle and the second internal angle are different, the collision avoidance apparatus 100 may calculate the difference between the two angles to determine the curvature of the curved section. The greater the difference between the two angles, the greater the curvature of the curved section of the path.

FIG. 7 illustrates a front sensing region which is referred to in some embodiments. The front sensing region of FIG. 7 may include a plurality of sensing regions set to sense an object to be avoided for fear of collision.

The collision avoidance apparatus 100 can set one or more distance-based sensing regions as described above. Referring to FIG. 7, the collision avoidance apparatus 100 may determine whether an object is detected in each of the set distance-based sensing regions. When determining that the object has been detected, the collision avoidance apparatus 100 may output a control signal for controlling the operation of the transport apparatus 10.

That is, in FIG. 7, the collision avoidance apparatus 100 may set three distance-based sensing regions 700 for respective distances. Referring to FIG. 7, the three distance-based sensing regions 700 may include a short-distance sensing region, a medium-distance sensing region, and a long-distance sensing region. In particular, a case where the short-distance sensing region is a region A is illustrated as an example in FIG. 7.

Here, the distance-based sensing regions 700 are regions of a forward image 701. The transport apparatus 10 may be driven in the straight direction, and the collision avoidance apparatus 100 may determine whether an object is detected in each of the set short-distance, middle-distance, and long-distance sensing regions.

For example, the collision avoidance apparatus 100 may detect an object in the area a1 included in the region A which is a short-distance sensing region.

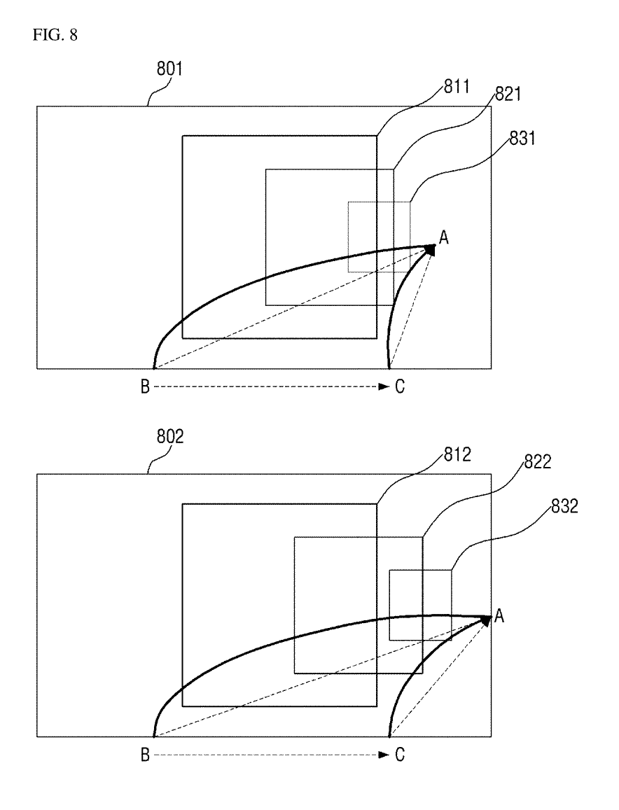

FIG. 8 illustrates a case where a sensing region is changed according to the traveling direction of the transport apparatus 10, which is referred to in some embodiments.

When the curvature of a curved section of a path is determined as described above with reference to the image 602 of FIG. 6, the collision avoidance apparatus 100 may change the position of a sensing region based on the determined curvature of the curved section.

Referring to FIG. 8, the sensing regions 700 of FIG. 7 are changed to sensing regions 811, 821 and 831 in an image 801. That is, while the three sensing regions 700 of FIG. 7 are arranged with respect to the vanishing point A, the sensing regions 811, 821 and 831 of the image 801 are arranged along a curved section. The collision avoidance apparatus 100 may also determine the positions of the sensing regions 811, 821 and 831 according to the curvature of the curved section.

That is, referring to an image 802, the transport apparatus 10 may travel along a curved section having a larger curvature in the image 802 than in the image 801. Here, sensing regions 812, 822 and 832 of the image 802 are located further toward the center of the curve than the sensing regions 811, 821 and 831 of the image 801, respectively.

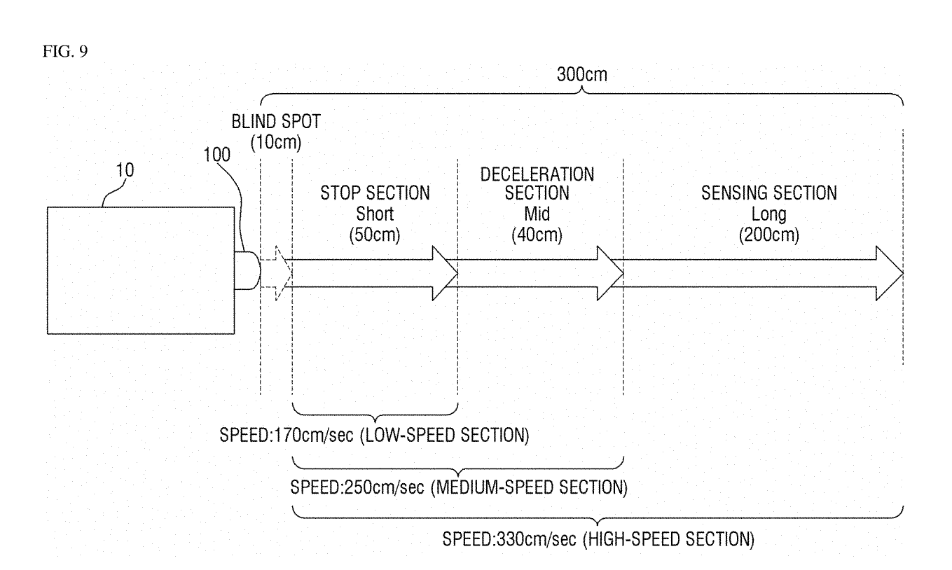

FIG. 9 illustrates a case where a sensing region is changed according to the traveling speed of the transport apparatus 10, which is referred to in some embodiments.

In operation S10, the collision avoidance apparatus 100 may measure the speed of the transport apparatus 10. To this end, the collision avoidance apparatus 100 may further include a component for measuring speed. Alternatively, the collision avoidance apparatus 100 may measure the speed using collected image information. That is, the collision avoidance apparatus 100 may measure the speed of the transport apparatus 10 by identifying the distance travelled to reach a specific point in a collected image with respect to time measured by a timer. In operation S20, the collision avoidance apparatus 100 may set a sensing region based on the measured speed.

In addition, when measuring the speed of the transport apparatus 10, the collision avoidance apparatus 100 may sense a change in the measured speed. Accordingly, the collision avoidance apparatus 100 may reset the set sensing region based on the sensed change in the measured speed.

Referring to FIG. 9, a region closest to the transport apparatus 10 within a certain distance from the transport apparatus 10 is a blind spot of the collision avoidance apparatus 100. It is assumed that the collision avoidance apparatus 100 has set three distance-based sensing regions such as a short-distance sensing region, a long-distance sensing region, and a middle-distance sensing region.

When the transport apparatus 10 receives a deceleration command from the collision avoidance apparatus 100 while traveling at low speed (a low-speed section), it may stop in a stop section. Therefore, when an object is located farther away from the transport apparatus 10 than the stop section, the object and the transport apparatus 10 do not collide with each other. In this case, the sensing region set within the stop section is enough. Since the middle-distance sensing region and the long-distance sensing region are unnecessary, the collision avoidance apparatus 100 can reduce the amount of computation by resetting the sensing regions so that the middle-distance and long-distance sensing regions are excluded.

Next, when the transport apparatus 10 receives a deceleration command from the collision avoidance apparatus 100 while travelling at medium speed (a medium-speed section), it passes the stop section and decelerates in a deceleration section. Therefore, the transport apparatus 10 can collide with an object in the deceleration section. In this case, the collision avoidance apparatus 100 may reset the positions of the short-distance and middle-distance sensing regions.

Lastly, when the transport apparatus 10 receives a deceleration command from the collision avoidance apparatus 100 while travelling at high speed (a high-speed section), it passes the stop section and the deceleration section and decelerates in a sensing section. Therefore, the transport 10 can collide with an object in the sensing section. In this case, the set sensing regions must be within an end point of the stop section, an end point of the deceleration section, and the sensing section. In particular, the collision avoidance apparatus 100 may reset the positions of the sensing regions to set an additional sensing region in order to avoid a collision in the sensing section.

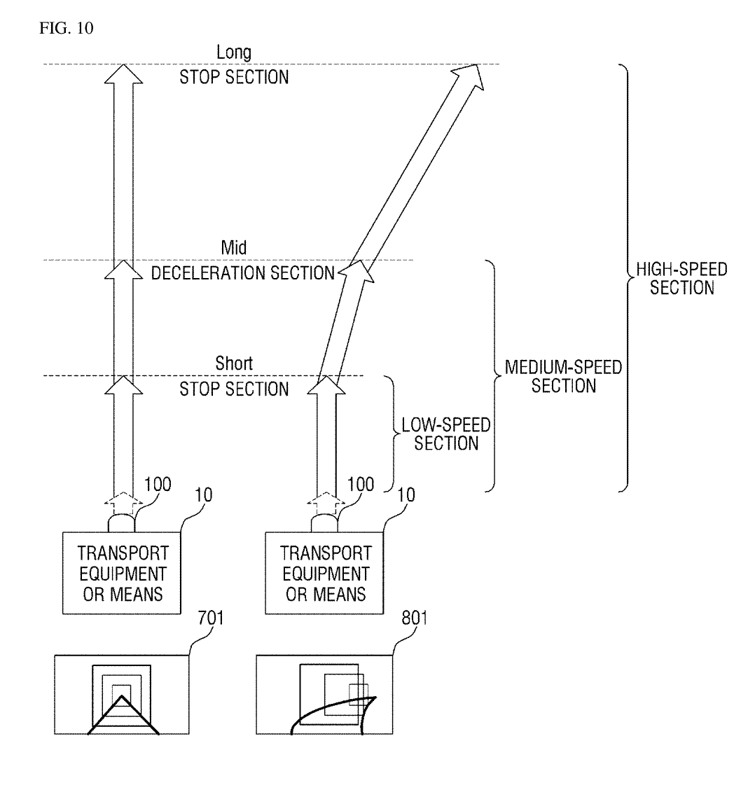

FIG. 10 illustrates a case where a sensing region is changed according to the traveling direction and speed of the transport apparatus 10, which is referred to in some embodiments.

Referring to FIG. 10, the collision avoidance apparatus 100 may set a distance-based sensing region by mixing the embodiments described above with reference to FIGS. 7 through 9.

In an example, the collision avoidance apparatus 100 may set a sensing region for each distance in a straight section as shown in an image 701 and reset the set sensing region based on the speed of the transport apparatus 10 or a change in the speed of the transport apparatus 10.

In another example, when the travelling path of the transport apparatus 10 is changed from the straight section as shown in the image 701 to a curved section as shown in an image 801, the collision avoidance apparatus 100 may change the sensing region set for each distance based on the curvature of the curved section. In addition, the collision avoidance apparatus 100 may measure the speed of the transport apparatus 10 or a change in the speed of the transport apparatus 10 while the transport apparatus 10 is travelling in the curved section. The collision avoidance apparatus 100 may reset the changed sensing region based on the speed or the change in the speed.

The methods according to the embodiments described above with reference to the attached drawings can be performed by the execution of a computer program implemented as computer-readable code. The computer program may be transmitted from a first computing device to a second computing device through a network, such as the Internet, to be installed in the second computing device and thus can be used in the second computing device. Examples of the first computing device and the second computing device include fixed computing devices such as a server and a desktop PC and mobile computing devices such as a notebook computer, a smartphone and a tablet PC.

According to the inventive concept, a method of avoiding a collision with an object using a depth sensor is provided. Therefore, a laser sensor such as an untruncated Gaussian beam (UGB) sensor may not be used. Hence, according to the inventive concept, it is not necessary to attach a reflector, select a target to which a non-reflector is to be attached, and perform an attachment work.

In addition, according to the inventive concept, a sensing region for sensing an object to be avoided for fear of collision can be changed according to the traveling path of a transport apparatus. Therefore, the accuracy of sensing the object to be avoided can be increased.

Furthermore, according to the inventive concept, a sensing distance to an object to be avoided for fear of collision is changed. Therefore, the amount of computation required to sense the object to be avoided can be optimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A collision avoidance method using a depth sensor, the method comprising:
receiving depth-based image information;
identifying a path in the received depth-based image information;
determining a depth level for each region of the depth-based image information;
setting at least one distance-based sensing region on the identified path based on the determined depth level;
determining whether an object is detected in the set at least one distance-based sensing region; and
in response to the object being detected, outputting a control signal for controlling an operation of a transport.

2. The method of claim 1, wherein the identifying of the path comprises identifying a curved section on a travel path of the transport apparatus based on the received depth-based image information, and
wherein the setting of the at least one distance-based sensing region on the identified path comprises changing the set at least one distance-based sensing region in response to the identifying of the curved section.

3. The method of claim 1, wherein the identifying of the path comprises:
identifying a track, which guides the transport apparatus, in the depth-based image information;
determining a start point, a second start point and a vanishing point of the track based on the received depth-based image information;
generating a first direction vector based on the first start point and the vanishing point, and generating a second direction vector based on the second start point and the vanishing point; and
determining whether a section on the path is straight or curved based on a length value of the first direction vector and a length value of the second direction vector.

4. The method of claim 3, wherein the determining of whether the section is straight or curved comprises determining a curvature of the section based on the length value of the first direction vector and the length value of the second direction vector when the section is determined to be curved.

5. The method of claim 4, wherein the setting of the at least one distance-based sensing region comprises:
changing the set at least one distance-based sensing region when the section is determined to be curved; and
changing at least one position corresponding to the set at least one distance-based sensing region based on the determined curvature of the section.

6. The method of claim 1, wherein the identifying of the path comprises:
identifying a track, which guides the transport apparatus, in the depth-based image information;
determining a first start point, a second start point and a vanishing point of the track based on the received depth-based image information;
generating a first direction vector based on the first start point and the vanishing point, generating a second direction vector based on the second start point and the vanishing point, and generating a third direction vector based on the first start point and the second start point; and
determining whether a section on the path is straight or curved based on a first angle between the first direction vector and the third direction vector and a second angle between the second direction vector and the third direction vector.

7. The method of claim 6, wherein the determining of whether the section is straight or curved comprises determining the curvature of the section based on the first angle and the second angle when the section is determined to be curved.

8. The method of claim 1, wherein the setting of the at least one distance-based sensing region comprises:
identifying a sensing region for each pre-stored depth level;
setting the at least one distance-based sensing region among the identified sensing region for each pre-stored depth level;
determining whether the object is detected in the set at least one distance-based sensing region; and
in response to the object being detected, outputting the control signal for controlling the operation of the transport apparatus.

9. The method of claim 8, wherein the determining of whether the object is detected in the set at least one distance-based sensing region comprises:
sensing an area representing a depth level matched to the set at least one distance-based sensing region in the at least one distance-based sensing region; and
determining that the object is detected when the area representing the matched depth level is sensed.

10. The method of claim 9, wherein the sensing of the area representing the matched depth level comprises sensing a movement of the area representing the matched depth level, and
wherein the determining that the object is detected comprises determining a moving state of the object when the movement of the area is sensed, and outputting the control signal for controlling the operation of the transport apparatus based on the determined moving state of the object.

11. The method of claim 1, wherein the identifying of the path comprises measuring a speed of the transport apparatus, and
wherein the setting of the at least one distance-based sensing region on the identified path comprises setting the at least one distance-based sensing region based on the measured speed.

12. The method of claim 11, wherein the measuring of the speed of the transport apparatus comprises sensing a change in the measured speed, and
wherein the setting of the at least one distance-based sensing region based on the measured speed comprises resetting the set at least one distance-based sensing region based on the sensed change in the measured speed.

13. A collision avoidance apparatus comprising:
an image collector configured to receive depth-based image information;
a controller configured to:
identify a path using the depth-based image information,
determine a depth level for each region of the depth-based image information,
set at least one distance-based sensing regions on the identified path based on the determined depth level,
determine whether an object is detected in the set at least one distance-based sensing region,
in response to the object being detected, generate a control signal for controlling an operation of a transport apparatus, and control the control signal to be output to the transport apparatus; and
a control signal output interface which outputs the control signal to the transport apparatus.

14. A non-transitory computer-readable medium containing instructions which, when executed by a computing device, cause the computing device to perform:
an operation of receiving depth-based image information;
identifying a path in the received depth-based image information;
an operation of determining a depth level for each region of the depth-based image information;
an operation of setting at least one distance-based sensing region on the identified path based on the determined depth level;
an operation of determining whether an object is detected in the set at least one distance-based sensing region; and
an operation of outputting a control signal for controlling an operation of a transport in response to determining that the object is detected.
